(19) United States
(12) Patent Application Publication
(10) Pub. No.: US 2004/0117576 A1
(43) Pub. Date: Jun. 17, 2004

(54) Storage unit, information processing apparatus, and access control method

(75) Inventors: Makoto Kobayashi, Kanagawa (JP); Tadashi Takayama, Kanagawa (JP); Noriyuki Suzuki, Tokyo (JP); Takeshi Toyama, Kanagawa (JP); Hiroyasu Ito, Kanagawa (JP); Tomoyuki Takada, Tokyo (JP); Kyohei Inukai, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/628,460

(22) Filed: Jul. 29, 2003

(30) Foreign Application Priority Data
Jul. 31, 2002 (JP) 2002-223733

(51) Int. Cl. G06F 12/14

(52) U.S. Cl. 711/163; 711/115

(57) ABSTRACT

This invention can reliably prevent removal of a disk unit by a person other than an authentic user while enabling sharing the disk unit between a plurality of users. An HDD unit (20) detachable from an information processing apparatus incorporates a memory which stores user information for user authentication, and a CPU which performs authentication processing by using the user information. If eject of the HDD unit (20) is designated, the HDD unit (20) executes authentication processing on the basis of authentication information input from the information processing apparatus in which the HDD unit (20) is mounted, and the user information stored in the memory. The HDD unit (20) notifies the information processing apparatus whether to permit/inhibit eject processing. If eject processing is permitted, the information processing apparatus ejects the HDD unit (20) by using a lock mechanism (21), motor controller (23), and the like.

### FIELD OF THE INVENTION

The present invention relates to a portable storage unit such as a disk unit, an information processing apparatus which allows detaching the storage unit, and an eject control method for the storage unit in the information processing apparatus.

### BACKGROUND OF THE INVENTION

In recent years, general disk units used by being inserted and connected to the slots of information processing apparatuses such as a personal computer are rapidly developed to a smaller size, higher speed, more advanced functions, larger capacity, and lower cost. At present, 1.8″ and 2.5″ memory card type disk units are commercially available. As the disk unit interface, standard interfaces such as SCSI, PCMCIA, and IDE have been spread. Any user can mount a disk unit in a host apparatus and use it.

The storage capacity of the disk unit increases year by year. For example, even a 2.5″ disk unit will soon reach a storage capacity of 100 GB. The storage capacity of a file server class several years ago can be easily carried by a compact disk unit. Such large-capacity disk unit is possessed and used by each user.

The disk unit of each user can be easily mounted in a host to read/write data. Most of data may contain personal data which must be kept unknown to another person. If data stored in the disk unit is easily read/written, data may be illicitly stolen or be destructed. Disk units are advanced for use by everyone, but security measures of data stored in the disk unit are not enough.

Recently, some disk units can set a password. For example, Japanese Patent Laid-Open No. 08-263383 discloses a disk unit which assumes use by a plurality of users and allows setting a plurality of passwords, usable capacities in correspondence with the respective passwords, and the authority for each capacity such as only read or both read and write in order to share the disk unit between a plurality of users.

Because of compactness, the disk unit can be easily taken away. The disk unit can be easily removed by any user by operating an eject button attached to the disk unit or host apparatus, or inputting disk unit eject designation by using a user interface (GUI) provided by software running on the OS of the host apparatus. Even a person other than an authentic user can easily remove the disk unit, and the disk unit itself may be stolen. Japanese Patent Laid-Open No. 2001-357587 discloses an apparatus which performs password authentication in ejecting a disk from a disk drive, thereby preventing an unauthorized user who does not know the password from taking away the disk.

For example, according to Japanese Patent Laid-Open No. 08-263383, the disk unit allows setting a plurality of passwords and can be shared between a plurality of users. However, this reference does not consider any measure against removal, i.e., eject processing of the disk unit. A person other than a plurality of users including an authentic owner may eject the disk unit from the host apparatus and take it away.

In Japanese Patent Laid-Open No. 2001-357587, authentication with a password stored in the disk drive is performed upon disk eject designation. This reference does not assume a plurality of disk drive users, and when use by another person is permitted, the unique password must be given, which impairs the effect of the password. The password is stored and authenticated by the disk drive. The disk drive itself is not portable, and a disk is ejected and carried instead. If the disk is inserted into another device and used, the disk can be used without any authentication in the new device. Hence, data may be illicitly used by another device or destructed. When a host apparatus is connected to a LAN (Local Area Network) and a disk drive is shared on the LAN, the disk drive may be ejected and taken away by a person other than the user who inserts and uses the disk drive.

Considering the conventional drawbacks, demands have arisen for a storage unit capable of reliably preventing removal of a disk unit by a person other than an authentic user while enabling sharing the disk unit between a plurality of users.

### SUMMARY OF THE INVENTION

According to one aspect of the present invention, there is provided a storage unit detachable from an information processing apparatus, comprising: storage means for storing user information for user authentication; authentication means for performing authentication processing on the basis of authentication information input from an information processing apparatus in which the storage unit is mounted, and user information stored in the storage means; and output means for outputting an authentication result of the authentication means.

According to another aspect of the present invention, there is provided an information processing apparatus which allows detaching a storage unit having storage means for storing user information for user authentication, authentication means for performing authentication processing on the basis of authentication information input from the information processing apparatus in which the storage unit is mounted, and user information stored in the storage means, and output means for outputting an authentication result of the authentication means, comprising: providing means for providing an interface for causing a user to input authentication information in executing predetermined processing for the storage unit; transmission means for transmitting the authentication information input via the interface to the storage unit; and execution means for executing the predetermined processing for the storage unit on the basis of the authentication result output from the output means in response to transmission of the authentication information.

According to another aspect of the present invention, there is provided an access control method for a storage unit detachable from an information processing apparatus, comprising: a registration step of registering user information for user authentication in a storage medium arranged in the storage unit; a providing step of providing an interface for causing a user to input authentication information in executing predetermined processing for the storage unit; an authentication step of causing the storage unit to execute authentication processing on the basis of the authentication information input via the interface and the user information registered in the registration step; and an execution step of executing the predetermined processing for the storage unit on the basis of an authentication result in the authentication step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the basic arrangement of an information processing apparatus in which a portable unit according to an embodiment of the present invention can be inserted, connected, and used;

FIG. 2 is a block diagram showing the basic arrangement of the portable unit according to the embodiment of the present invention;

FIG. 3 is a table showing various pieces of information for user authentication that are stored in the portable unit according to the embodiment of the present invention;

FIG. 4 is a view showing a display example of a GUI for inputting a user ID and password as user authentication in ejecting an HDD unit according to the embodiment of the present invention;

FIG. 5 is a flow chart showing processing performed by the portable unit according to the embodiment of the present invention in ejecting an inserted HDD unit; and

FIG. 6 is a flow chart for explaining utility processing by a driver application for an HDD slot that is executed in a host computer.

### DETAILED DESCRIPTION OF THE PREFERRED EMBODIMENT

A preferred embodiment of the present invention will now be described in detail in accordance with the accompanying drawings.

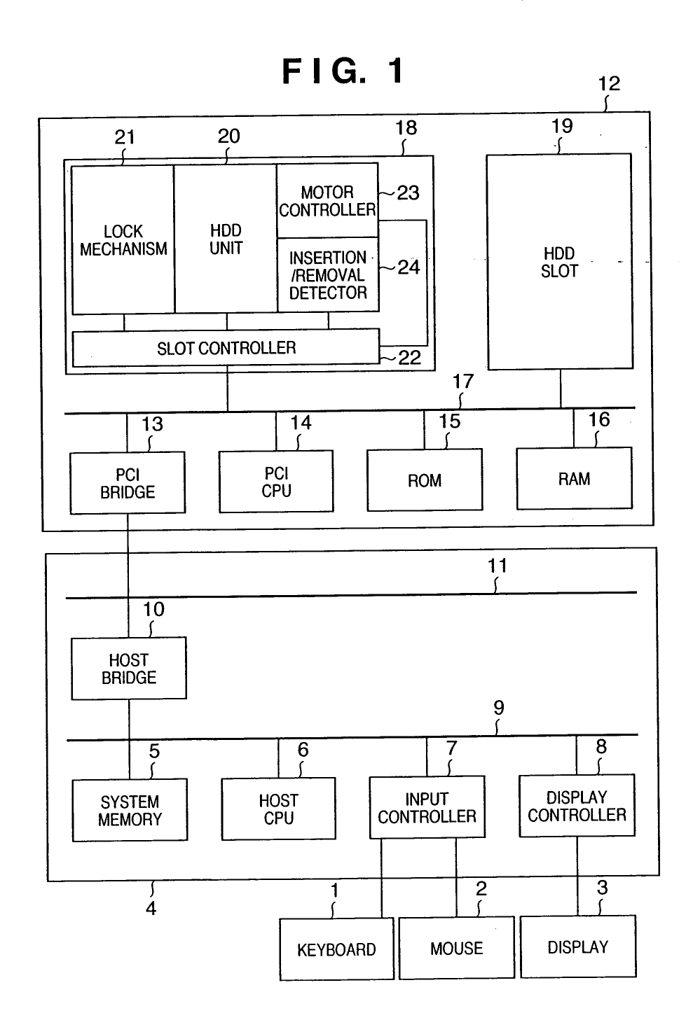

FIG. 1 is a block diagram showing the basic arrangement of an information processing apparatus serving as a host apparatus in which a portable storage unit according to the embodiment of the present invention is inserted, connected, and used. The information processing apparatus shown in FIG. 1 is roughly divided into two parts: a motherboard 4 and a PCI board 12 connected to it except a keyboard 1, mouse 2, and display 3.

In the motherboard 4, reference numeral 6 denotes a host CPU (Central Processing Unit) which executes various programs; 5, a system memory which stores programs executed by the host CPU 6, various data to be processed by the host CPU 6, and data used for processing: 7, an input controller which receives data input from the keyboard 1 and mouse 2; 8, a display controller which causes the display 3 to display various pieces of information under the control of the host CPU 6; and 10, a host bridge which arbitrates between a host bus 9 and PCI (Peripheral Connect Interface) bus 11. The PCI bus 11 has PCI expansion slots capable of connecting a plurality of boards.

In the embodiment, one of PCI expansion slots is connected to one PCI board 12. The PCI board 12 is equipped with a PCI bridge 13 which arbitrates between the PCI bus 11 and a local bus 17 on the PCI board 12.

In addition to the PCI bridge 13, the PCI board 12 comprises a PCI CPU 14 which executes various processing programs in the PCI board 12, a ROM (Read Only Memory) 15 which stores programs executed by the PCI CPU 14, and a RAM (Random Access Memory) 16 which stores data to be processed by the PCI CPU 14 on the basis of programs stored in the ROM 15. The PCI board 12 also comprises HDD slots 18 and 19 which allow inserting/removing a removable hard disk unit (HDD unit) 20 and can be connected to the PCI board 12. The HDD units 18 and 19 are connected to the local bus 17 on the PCI board 12, and can exchange various data. FIG. 1 illustrates the internal structure of only one HDD slot 18 out of the two HDD slots. The other HDD slot 19 also has the same structure (not shown in FIG. 1).

The structure of the HDD slot 18 will be explained. A slot controller 22 is connected to the local bus 17 on the PCI board 12, and controls various operations within the HDD slot 18. The HDD unit 20 is a removable hard disk which can be inserted/removed to/from and connected to the HDD slot 18.

The HDD slot 18 comprises an insertion/removal detector 24, motor controller 23, and lock mechanism 21. The insertion/removal detector 24 detects insertion/removal of the HDD unit 20 into/from the HDD slot 18. The motor controller 23 has a motor which performs loading for ejecting the HDD unit 20 from the HDD slot 18 or correctly connecting the inserted HDD unit 20, and a controller which controls the motor. The lock mechanism 21 physically latches and locks the inserted HDD unit 20 so as not to unintentionally remove the inserted HDD unit 20.

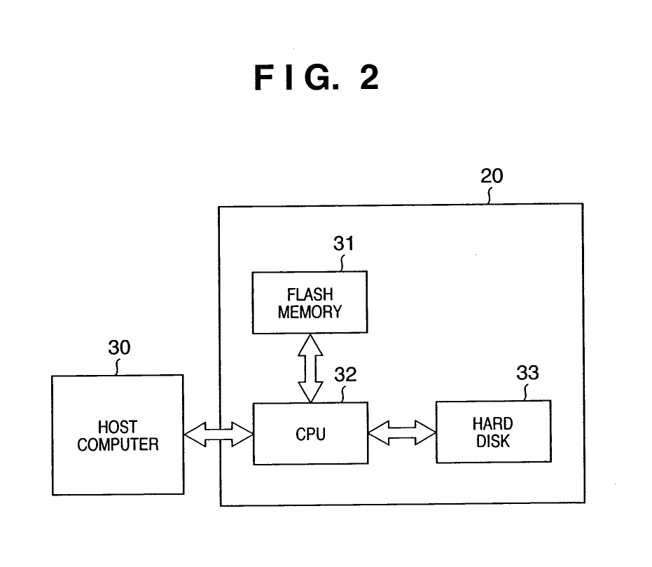

The HDD unit 20 will be explained with reference to FIG. 2. FIG. 2 is a block diagram showing the basic arrangement of the portable storage unit, i.e., the HDD unit 20 according to the embodiment of the present invention.

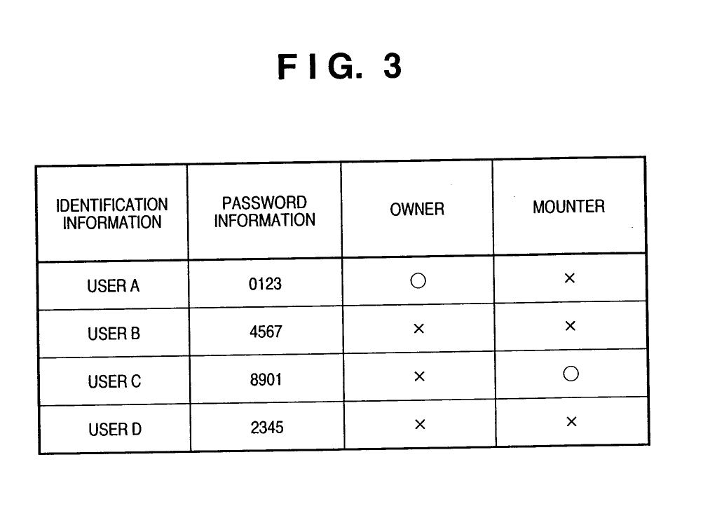

The HDD unit 20 comprises a CPU 32 which executes various processing programs in the HDD unit 20, a hard disk 33 which stores various user data, application software, and the like, and a FLASH memory 31 which stores programs and various data executed by the CPU 32 as a storage area other than the hard disk 33. The CPU 32 communicates various data with a host computer 30 serving as a host apparatus as shown in FIG. 1. Various data stored in the FLASH memory 31 shown in FIG. 2 include various pieces of user information to be described later with reference to FIG. 3.

User information will be described with reference to FIG. 3. FIG. 3 shows a data structure example of user information stored in the FLASH memory 31 of the portable storage unit, i.e., the HDD unit 20 according to the embodiment. In the embodiment, pieces of information on for users are registered as user identification information, and “user A”, “user B”, “user C”, and “user D” are pieces of identification information. The embodiment will exemplify four users, but the number of users can be arbitrarily set. In order to identify an individual, information such as the user's name which can specify the user is generally registered and used as identification information. Various pieces of information are registered and stored in correspondence with pieces of identification information. The embodiment will describe “password information”, “owner”, and “mounter”.

The password information is used to authenticate each user for the use of the HDD unit 20 when he/she inserts and connects the HDD unit 20 into the host computer 30 and uses the HDD unit 20. For example, a window which prompts input of identification information and a password is displayed on the display 3 of the host computer 30 (1) when the HDD unit is inserted and connected, (2) upon the first access to the HDD unit, or (3) when mounting of the HDD unit is detected upon power-on of the host computer 30. The user inputs his/her identification information and password from the keyboard 1. In the example of FIG. 3, “user A”, “user B”, “user C”, and “user D” are pieces of registered identification information, and “0123”, “4567”, “8901”, and “2345” are pieces of corresponding password information. In the embodiment, password information is a four-digit number. Another number of digits, characters, or authentication data using a biometric technique such as fingerprint authentication may also be adopted. As password information, a result of performing predetermined encryption in the HDD unit 20 may be stored.

Of pieces of user information, “owner” will be explained. “Owner” represents the owner of the HDD unit 20. In general, almost all things including a portable storage unit belong to owners. In the embodiment, the owner is one “user A”, but may be another person or a plurality of persons. In the embodiment, the difference between the owner and a user who is not the owner is that a person who manages the HDD unit 20 is the owner. When the owner purchases the HDD unit 20 and uses it for the first time, he/she registers that the HDD unit 20 belongs to him/her. At this time, owner's identification information and password information are also registered and used. The owner then registers persons who can share the HDD unit 20. That is, the owner registers users who can access various data stored in the HDD unit 20. The persons who are registered later are generally users who are not the owner.

“Mounter” will be explained. The mounter is a user who is first authenticated and permitted for use every time the HDD unit 20 is inserted and connected to the host computer 30 and used. The mounter is registered in identification information by the owner, and permitted by the owner to use the HDD unit 20. “Mounter” is a user who connects the HDD unit 20 and is first authenticated, and is limited to one person. In the embodiment, “user C” is registered as a mounter. Also, a person who is first authenticated when the apparatus is powered off and then on while the HDD unit 20 is kept connected becomes a mounter. That is, a mounter before power-off is not always a mounter. “Mounter” is initialized to a state wherein no mounter exists upon power-on of the HDD unit 20. A nonvolatile RAM may be newly arranged to store “mounter”.

It is possible to store “identification information”, “password information”, and “owner” out of pieces of user information in a backed-up nonvolatile memory, and store “mounter” in a nonvolatile RAM or the like. It is also possible to store all pieces of user information in the FLASH memory 31, and initialize “mounter” under the control of the CPU 32 upon power-on, like the embodiment.

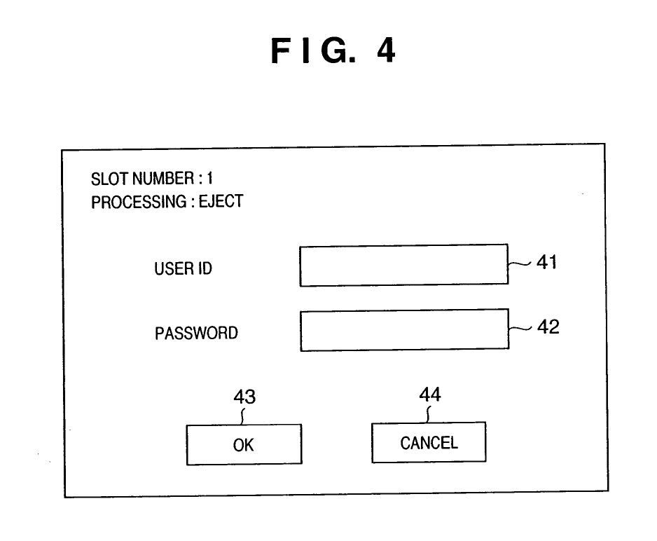

An example in FIG. 4 will be explained. FIG. 4 shows an example of a GUI displayed on the display 3 via the display controller 8 when the portable storage unit, i.e., the HDD unit 20 according to the embodiment is ejected from the information processing apparatus shown in FIG. 1. The GUI allows confirming whether the user is authorized to eject and bring out the HDD unit 20. In ejecting the HDD unit 20, the user inputs his/her user ID, i.e., “identification information” in a user ID input area 41 and “password information” in a password input area 42 in accordance with the GUI shown in FIG. 4. If the user clicks an “OK” button 43, authentication between the pieces of input information and pieces of user information stored in the FLASH memory 31 of the HDD unit 20 is executed. If the user clicks a “CANCEL” button 44, the eject operation is canceled. Movement to each area, and clicking of the “OK” button 43 and “CANCEL” button 44 are done with the mouse 2.

The information processing apparatus serving as a host apparatus in which the portable storage unit according to the embodiment is inserted, connected, and used has a basic arrangement shown in FIG. 1. The portable storage unit (HDD unit 20) according to the embodiment has a basic arrangement shown in FIG. 2. An example of user information which is stored in the portable storage unit according to the embodiment and used for user authentication is shown in FIG. 3. The GUI used for authentication in eject is shown in FIG. 4.

The operation of the host apparatus which performs registration of user information in the HDD unit, eject designation (eject insruction), and the like will be explained. A driver application dedicated to control the HDD slots 18 and 19 is installed in the system memory 5 of the information processing apparatus serving as a host apparatus, and controls access to the HDD unit 20 inserted/connected to the slot and carrying of the HDD unit 20. The driver application includes a utility which provides user interfaces for input of authentication information, user registration, eject designation, and the like.

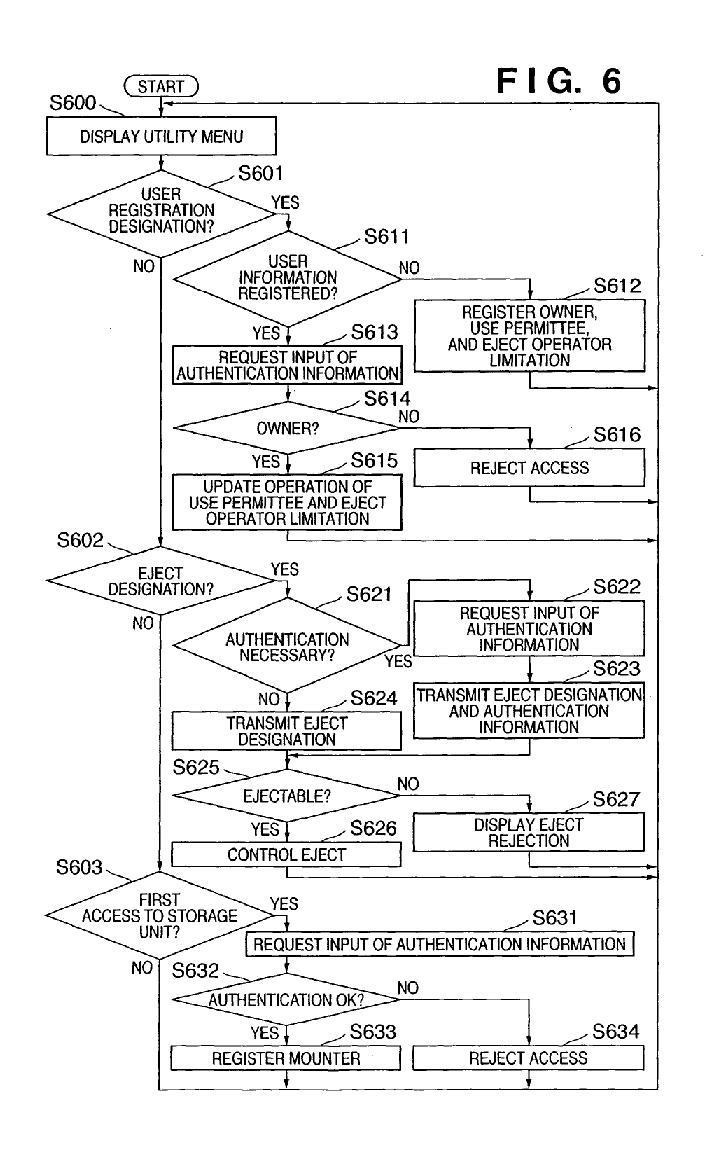

FIG. 6 is a flow chart for explaining utility processing by the driver application for the HDD slot 18. If the utility is executed, a menu window (not shown) for selecting an operation such as “user registration” or “eject” is displayed (step S600). If “user registration” is designated on the menu window, the processing advances from step S601 to step S611 to inquire of the CPU 32 of the HDD unit 20 whether user information has been registered. If NO in step S611, the processing advances from step S611 to step S612 to present on the display 3 a user interface for registering “owner”, “use-permitted person (identification information and password information)”, and a limitation on an eject operator (eject operator limitation information). The limitation on an eject operator (eject operator limitation information) is a limitation on execution of eject operation to a registrant or a limitation to an owner and mounter (in this example, any one of “all registrants can eject the HDD unit 20”, “only the mounter can eject the HDD unit 20”, “only the owner can eject the HDD unit 20”, and “only the mounter or owner can eject the HDD unit 20”), which will be described in detail later. Identification information, password information, and “owner” information input with the user interface are transmitted to the HDD unit 20, and stored in the FLASH memory 31 under the control of the CPU 32. Eject operator limitation information representing the limitation on an eject operator is also stored in the FLASH memory 31.

If YES in step S611, one or more use-permitted persons and the owner are registered. In step S613, a user interface for inputting authentication information is presented, and authentication processing is performed. If the user is authenticated on the basis of the identification information and password information registered in the user information and is “owner”, the processing advances from step S614 to step S615 to provide a user interface for performing use-permitted person update operation (e.g., addition/delete of identification information and a password) and eject operator limitation update operation. If NO in step S614, the processing advances to step S616 to reject user registration designation.

If “eject” is designated on the menu, the processing advances from step S602 to step S621 to determine whether to perform authentication (i.e., whether the eject operator limitation has been registered). Whether the eject operator is limited can be determined by acquiring information on the eject operator limitation from the HDD unit by polling (to be described later). If YES in step S621, the processing advances from step S621 to step S622 to present a user interface as shown in FIG. 4 for inputting authentication information. In step S623, eject designation, and user information (identification information and password information) input in the user interface are transmitted to the HDD unit 20. The processing then advances to step S625.

If NO in step S621, the processing advances to step S624 to transmit eject designation.

In step S625, the processing waits for an eject enable/disable signal from the HDD unit 20. If eject permission is input, the HDD slot 18 or 19 is controlled to eject the HDD unit 20 (steps S625 and S626). If no eject permission is input from the HDD unit 20, a message that eject designation is rejected is displayed on the display (step S627).

Processes in steps S621 to S627 may start upon detecting operation on an eject button (not shown) arranged on the HDD unit 20 or the HDD slot 18 or 19.

The utility of the embodiment executes “mounter” registration processing, in addition to designation by selecting operation from the menu. In the embodiment, upon access to the HDD unit 20, whether the mounter has been registered is determined, and if no mounter is registered, this access is determined as the first access. As described above, “mounter” is initialized upon activation of the apparatus. Upon access to the HDD unit 20, whether the mounter has been registered is determined, and if no mounter has been registered, a user interface which prompts input of authentication information is provided (steps S603 and S631). Whether the mounter has been registered can be grasped by inquiring a mounter registration status from the HDD unit 20 by, e.g., polling. If the user is authenticated on the basis of identification information and password information, the user is registered as a mounter, and permitted to access the HDD unit 20 (steps S632 and S633). If the user is not authenticated, the access is rejected (step S634). In access rejection in steps S616 and S634, a message to this effect may be displayed on the display 3.

Processing in the portable storage unit when the portable storage unit (HDD unit 20) inserted into the information processing apparatus is physically ejected in response to the above-mentioned eject designation will be explained.

As described above, when the HDD unit 20 inserted and connected to either of the HDD slots 18 and 19 is to be ejected, the operator inputs eject designation of the HDD unit by using the mouse 2, keyboard 1, or the like. The input eject designation is input to the host CPU 6 via the input controller 7. Alternatively, the eject button (not shown) of the HDD unit 20 is pressed to notify the host CPU 6 of the eject designation via the slot controller 22, PCI bridge 13, and host bridge 10. The host CPU 6 detects the eject designation, and if necessary, performs authentication of the connected HDD unit 20 in order to confirm whether the operator is authorized to eject and bring out the HDD unit 20.

The host computer 30 polls the HDD unit 20 and acquires various pieces of information in advance in order to recognize the type of connected HDD unit 20, its function, and its registration status. If the host computer 30 serving as a host apparatus detects that the user is limited, the GUI shown in FIG. 4 is displayed on the display 3 via the display controller 8 in order to confirm whether the operator is permitted to eject the HDD unit 20. The operator uses the keyboard 1 to input his or her user ID, i.e., identification information in the user ID input area 41 and password information in the password input area 42, and uses the mouse 2 to click the “OK” button 43. In response to this, authentication with pieces of user information stored in the FLASH memory 31 of the HDD unit 20 is performed (S621 to S623).

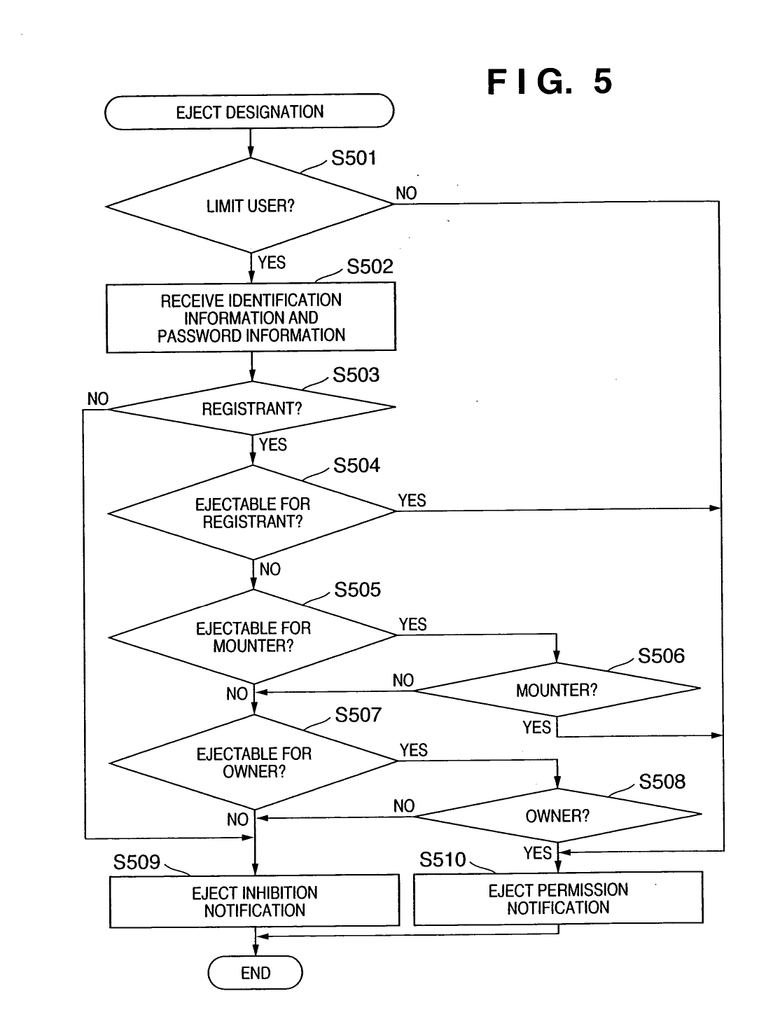

The user ID, i.e., identification information and password information input via the GUI shown in FIG. 4 are transmitted to the HDD unit 20 via the host bridge 10, PCI bridge 13, and slot controller 22 together with eject designation (S623). The CPU 32 of the HDD unit 20 which has received the eject designation determines whether to eject in accordance with the flow chart shown in FIG. 5.

A flow of determining whether to permit eject upon reception of eject designation by the CPU 32 of the HDD unit 20 will be explained with reference to the flow chart of FIG. 5.

Upon reception of eject designation from the host computer 30 serving as a host apparatus, the HDD unit 20 checks whether the current mode is a mode in which the user is limited (in this case, the eject operator is limited) (step S501). Whether to limit the user is registered and stored in the FLASH memory 31 in advance. In this example, the eject operator is limited to any one of “all registrants can eject the HDD unit 20”, “only the mounter can eject the HDD unit 20”, “only the owner can eject the HDD unit 20”, and “only the mounter or owner can eject the HDD unit 20”. If no identification information has been registered, user limitation may be determined not to be performed.

If NO in step S501, the HDD unit 20 shifts to a state in which connection to the host computer 30 serving as a host apparatus can be canceled. For example, the HDD unit 20 performs end processing such as retreat of a cache memory (not shown), and shifts to a state in which the HDD unit can be powered off by eject without any problem. The HDD unit 20 notifies the host computer 30 that the HDD unit 20 can be ejected (step S510). The host computer 30 which has received the notification that the HDD unit 20 can be ejected unlocks the HDD unit 20 by the lock mechanism 21 via the slot controller 22 of the designated HDD slot 18. The host computer 30 operates the motor controller 23, and ejects the designated/permitted HDD unit 20.

If YES in step S501, identification information and password information of the eject-designating user that are transmitted successively to the eject designation are received (step S502). A user ID and password input via the GUI shown in FIG. 4 are received as identification information and password information, respectively.

Whether the received identification information and password information coincide with identification information and password information registered in the FLASH memory 31 is determined (step S503). In the example of FIG. 3, “user A”, “user B”, “user C”, and “user D” are pieces of registered identification information, and “0123”, “4567”, “8901”, and “2345” are pieces of corresponding password information. If information encrypted by predetermined cryptography is registered as password information, the received password also similarly undergoes the predetermined cryptography, and the result is compared with the registered password information.

If it is determined in step S503 that identification information and password information which coincide with the received identification information and password information are not registered in the FLASH memory 31, the host computer 30 serving as a host apparatus is notified that eject is inhibited and not permitted (step S509). The host computer 30 which has received the notification that eject is inhibited does not eject the designated HDD unit 20. Although not shown, the host computer 30 may display on the display 3 using a GUI a message that eject is not permitted, or notify the user of a message to this effect by error sound or the like.

If YES in step S503, the user who is permitted for eject is confirmed on the basis of eject operator limitation information. As the eject operator limitation information according to the embodiment, four types: “all registrants can eject the HDD unit 20”, “only the mounter can eject the HDD unit 20”, “only the owner can eject the HDD unit 20”, and “only the mounter or owner can eject the HDD unit 20” can be set, and any one of them is set. Whether “all registrants can eject the HDD unit 20” has been registered is checked (step S504).

If YES in step S504, the resistant has already been confirmed in step S503, and the processing advances to step S510 to perform predetermined end processing. The host computer 30 serving as a host apparatus is notified that eject is permitted. The host computer 30 which has received the notification that eject is permitted unlocks the HDD unit 20 by the lock mechanism 21 via the slot controller 22 of the designated HDD slot 18. The host computer 30 operates the motor controller 23, and ejects the designated/permitted HDD unit 20 (S626).

If NO in step S504, whether the mounter can eject the HDD unit 20 is checked (step S505). That is, if “only the mounter can eject the HDD unit 20” or “only the mounter or owner can eject the HDD unit 20” has been registered, whether the identification information and password information received in step S502 are those of the mounter is checked (step S506).

In the example of FIG. 3, the mounter is “user C”. If “user C” designates eject, the user is the mounter, and the processing advances to step S510 to perform predetermined end processing. The host computer 30 serving as a host apparatus is notified that eject is permitted. The host computer 30 which has received the notification that eject is permitted unlocks the HDD unit 20 by the lock mechanism 21 via the slot controller 22 of the designated HDD slot 18. The host computer 30 operates the motor controller 23, and ejects the designated/permitted HDD unit 20 (S626).

If NO in step S505 or S506, whether the owner can eject the HDD unit 20 is checked (step S507). That is, if “only the owner can eject the HDD unit 20” or “only the mounter or owner can eject the HDD unit 20” has been registered, whether the identification information and password information received in step S502 are those of the mounter is checked (step S508).

In the example of FIG. 3, the owner is “user A”. If “user A” designates eject, the user is the owner, and the processing advances to step S510 to perform predetermined end processing. The host computer 30 serving as a host apparatus is notified that eject is permitted. The host computer 30 which has received the notification that eject is permitted unlocks the HDD unit 20 by the lock mechanism 21 via the slot controller 22 of the designated HDD slot 18. The host computer 30 operates the motor controller 23, and ejects the designated/permitted HDD unit 20 (S626).

If NO in step S507 or S508, the host computer 30 serving as a host apparatus is notified that eject is inhibited and not permitted (step S509).

The host computer 30 which has received the notification that eject is inhibited does not eject the HDD unit 20. Although not shown, the host computer 30 may display on the display 3 using a GUI a message that eject is not permitted, or notify the user of a message to this effect by error sound or the like.

Processing by the CPU 32 in the HDD unit 20 upon eject designation to the HDD unit 20 has been described.

The embodiment has described the use of a removable hard disk. The present invention can also be applied to another storage unit such as a flexible disk or memory stick, or another portable storage unit.

The embodiment has described operation of ejecting the HDD unit 20 inserted into the HDD slot 18. The operation of ejecting another HDD unit 20 inserted into the HDD slot 19 is also the same. That is, the above-described processing is executed in eject at each slot.

Different pieces of user information such as identification information and password information can be registered for different HDD units 20.

Various pieces of user information are stored in the FLASH memory 31 in the embodiment, but may also be stored in the hard disk 33.

As described above, according to the embodiment, a portable storage unit is inserted into a host apparatus. Authentication information for determining whether to permit/inhibit access to the portable storage unit used upon connection is stored not in the host apparatus but in the portable storage unit. The portable storage unit performs authentication for eject designation (i.e., whether the user is permitted for eject) on the basis of identification information and password information which are input from the host apparatus. This can prevent a user not intended by the owner from removing the portable storage unit.

According to the embodiment, limitations on an eject permittee can be flexibly set such that (1) all users whose information is stored in the portable storage unit (users whose identification information and password information are registered) are permitted to eject the portable storage unit, (2) a user who is a mounter is permitted to eject the portable storage unit, or (3) a user who is an owner is permitted to eject the portable storage unit.

The object of the present invention is also achieved when a storage medium which records software program codes for realizing the functions of the above-described embodiment is supplied to a system or apparatus, and the computer (or the CPU or MPU) of the system or apparatus reads out and executes the program codes stored in the storage medium.

In this case, the program codes read out from the storage medium realize the functions of the above-described embodiment, and the storage medium which stores the program codes constitutes the present invention.

The storage medium for supplying the program codes includes a floppy disk, hard disk, optical disk, magnetooptical disk, CD-ROM, CD-R, magnetic tape, nonvolatile memory card, and ROM.

The functions of the above-described embodiment are realized when the computer executes the readout program codes. Also, the functions of the above-described embodiment are realized when an OS (Operating System) or the like running on the computer performs part or all of actual processing on the basis of the instructions of the program codes.

The functions of the above-described embodiment are also realized when the program codes read out from the storage medium are written in the memory of a function expansion board inserted into the computer or the memory of a function expansion unit connected to the computer, and the CPU of the function expansion board or function expansion unit performs part or all of actual processing on the basis of the instructions of the program codes.

As has been described above, the present invention can reliably prevent removal of a disk unit by a person other than an authentic user while enabling sharing the disk unit between a plurality of users.

As many apparently widely different embodiments of the present invention can be made without departing from the spirit and scope thereof, it is to be understood that the invention is not limited to the specific embodiments thereof except as defined in the claims.

What is claimed is:

1. A storage unit detachable from an information processing apparatus, comprising:
storage means for storing user information for user authentication;
authentication means for performing authentication processing on the basis of authentication information input from an information processing apparatus in which the storage unit is mounted, and user information stored in said storage means; and
output means for outputting an authentication result of said authentication means.

2. The unit according to claim 1, wherein
said authentication means performs authentication on the basis of authentication information transmitted from the information processing apparatus together with eject instruction, and the user information stored in said storage means, and
said output means notifies the information processing apparatus of eject permission when authentication by said authentication means is successful.

3. The unit according to claim 2, wherein
the user information includes a pair of identification information and password information which specify a user, and
said authentication means determines that authentication is successful when a pair of identification information and password information contained in the authentication information are contained in the user information.

4. The unit according to claim 3, wherein
the user information contains an attribute assigned to a user, and
said authentication means determines that authentication is successful when the pair of identification information and password information contained in the authentication information are contained in the user information and a user specified by the pair of identification information and password information is assigned a predetermined attribute.

5. The unit according to claim 4, wherein the predetermined attribute includes mounter information which specifies a user who is first permitted to access the storage unit.

6. The unit according to claim 4, wherein the predetermined attribute information includes owner information representing an owner of the storage unit.

7. The unit according to claim 4, wherein
the unit further comprises holding means for holding designation information which designates an attribute to be used for authentication processing by said authentication means, and
said authentication means determines that authentication is successful when the user specified by the pair of identification information and password information contained in the authentication information is assigned the attribute designated by the designation information.

8. An information processing apparatus which allows detaching a storage unit having
storage means for storing user information for user authentication,
authentication means for performing authentication processing on the basis of authentication information input from the information processing apparatus in which the storage unit is mounted, and user information stored in the storage means, and
output means for outputting an authentication result of the authentication means, comprising:
providing means for providing an interface for causing a user to input authentication information in executing predetermined processing for the storage unit;
transmission means for transmitting the authentication information input via the interface to the storage unit; and
execution means for executing the predetermined processing for the storage unit on the basis of the authentication result output from the output means in response to transmission of the authentication information.

9. The apparatus according to claim 8, wherein the predetermined processing includes eject processing for the storage unit.

10. An access control method for a storage unit detachable from an information processing apparatus, comprising:
a registration step of registering user information for user authentication in a storage medium arranged in the storage unit;
a providing step of providing an interface for causing a user to input authentication information in executing predetermined processing for the storage unit;
an authentication step of causing the storage unit to execute authentication processing on the basis of the authentication information input via the interface and the user information registered in the registration step; and
an execution step of executing the predetermined processing for the storage unit on the basis of an authentication result in the authentication step.

11. The method according to claim 10, wherein the predetermined processing includes eject processing for the storage unit.

12. A control program for causing an information processing apparatus which allows detaching a storage unit to execute predetermined processing for the storage unit, the storage unit having
storage means for storing user information for user authentication,
authentication means for performing authentication processing on the basis of authentication information input from the information processing apparatus in which the storage unit is mounted, and user information stored in the storage means, and
output means for outputting an authentication result of the authentication means, eject processing comprising:
a providing step of providing an interface for causing a user to input authentication information in executing the predetermined processing for the storage unit;
a transmission step of transmitting the authentication information input via the interface to the storage unit;
a reception step of receiving the authentication result output from the output means in response to transmission of the authentication information; and
an execution step of executing the predetermined processing for the storage unit on the basis of the authentication result.

13. A computer-readable memory which stores a control program defined in claim 12.
